(19) United States
(12) Patent Application Publication
(10) Pub. No.: US 2002/0078388 A1
(43) Pub. Date: Jun. 20, 2002

(54) Remote power up control for delivery of information

(76) Inventor: Michael C. Wickham, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/745,631

(22) Filed: Dec. 18, 2000

(51) Int. Cl. G06F 1/26; G06F 1/28; G06F 1/30

(52) U.S. Cl. 713/300

(57) ABSTRACT

A computer is revived from a power saving mode with a power revive code. A link to a server is opened. The server is searched for the power revive code. If present, the power revive code is received by the computer. The power revive code is deciphered to discover an associated application and activity. Examples of associated applications include an electronic mail viewer, an Internet browser, and an information monitoring application. Power save mode is exited. The associated application is launched and the associated activity is initiated.

### FIELD OF THE INVENTION

This invention relates in general to power management in a computing device and, more particularly, to a method and system for remotely initiating power revival in a computing device for delivery of information.

### BACKGROUND OF THE INVENTION

Many users of battery powered computing devices shut down the devices for extended periods throughout the day in order to retain battery charge. Examples of battery powered computing devices include cellular telephones and laptop, palmtop, and hand held computers. During the time these devices are shut down, they are not able to communicate and do not receive information.

It is often desirable for a user of one of these battery powered computing devices to receive immediate notification of particular events. For example, a user may await an email message or a notification when a stock reaches a specific price.

Often the user would like to receive this notification through the battery powered computing device. In order to do so, it has conventionally been necessary for the user to either leave the device powered up or to periodically power up the device, check for the information, and then shut down the device. Leaving the device powered up allows for automated checking for information, but consumes a significant amount of battery charge. Periodically powering up the device consumes somewhat less battery charge, but is time demanding for the user.

Many of these battery powered devices have a power saving or standby mode during which little or no computing activity takes place and battery charge consumption is significantly reduced over normal powered up mode. Entering and exiting power save mode is often accomplished with less time than powering up and shutting down the device.

Putting the device in power saving mode between checks for information has been one way in which users have lessened the time demand required for checking for the information. However, a solution that required less time from the user and required less battery charge would be desirable.

### SUMMARY OF THE INVENTION

According to principles of the present invention, a power revive code revives a computer from a power saving mode. A link to a server is opened. The server is searched for a power revive code. The power revive code is received. The power revive code is deciphered to discover an associated application and activity. Power save mode is exited. The associated application is launched and the activity is initiated. The associated application may include an electronic mail view, an Internet browser, or an information monitoring application.

### DESCRIPTION OF THE DRAWINGS

FIG. 1 is a block diagram representing one embodiment of the present invention system for reviving a computer from a power saving mode.

FIG. 2 is a flow chart illustrating one embodiment of the present invention method for reviving a computer from a power saving mode.

### DETAILED DESCRIPTION OF THE INVENTION

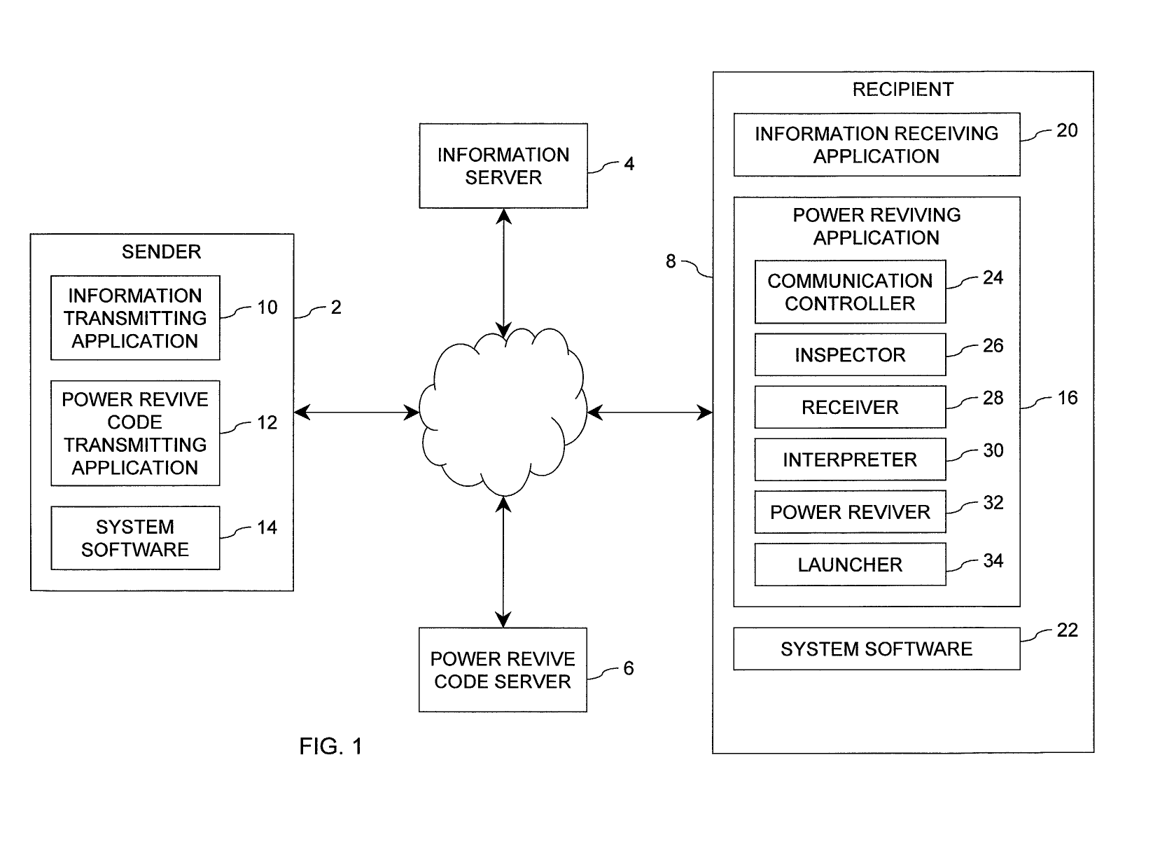

Illustrated in FIG. 1 are a sender 2, an information server 4, a power revive code server 6, and a recipient 8. Sender 2 and recipient 8 are each able to communicate with information server 4 and power revive code server 6. In one embodiment, sender 2, information server 4, power revive code server 6, and recipient 8 are each separate devices. In an alternative embodiment, information server 4 and power revive code server 6 are embodied in the same device. In another alternative embodiment, either individually or jointly, information server 4 and power revive code server 6 are embodied in the same device as sender 2. In still another alternative embodiment, either individually or jointly, information server 4 and power revive code server 6 are embodied in the same device as recipient 8.

Sender 2 is any device or system for originating an information transmission addressed to recipient 8. Sender 2 includes an information transmitting application 10, a power revive code transmitting application 12, and system software 14. In one embodiment, power revive code transmitting application 12 is a separate application from information transmitting application 10. In an alternate embodiment, information transmitting application 10 and power revive code transmitting application 12 are embodied within the same application. Furthermore, information transmitting application 10 and power revive code transmitting application 12 may each be embodied in stand alone applications or incorporated into system software 14.

Information transmitting application 10 is any application executable on sender 12 for transmitting information addressed to recipient 8. For example, information transmitting application 10 may be an email application.

Power revive code transmitting application 12 is any application executable on sender 12 for transmitting a power revive code addressed to recipient 8. A power revive code is defined to be any sequence of data, which when received by recipient 8 will revive recipient 8 from power saving mode, as will be described in more detail below.

System software 14 is any combination of executable code that provides an operating environment on sender 2. System software 14 may be embodied in firmware, such as in a bios, or software, such as in an operating system.

Information server 4 is any device or system acting as a server for information. Information server 4 receives information transmitted by sender 4 and holds the information for retrieval by recipient 8. Examples of information server 4 include an email server, a data server, and a file server.

Power revive code server 6 is any device or system acting as a server for a power revive code. Power revive code server 6 receives a power revive code from sender 2 and holds the power revive code for retrieval by recipient 8.

Recipient 8 is any device or system, such as a specific or general purpose computer, that includes a means, such as a processor, for processing executable code. Furthermore, recipient 8 is able to enter into a power saving, or standby, mode and be revived from the power saving mode. Examples of recipient 8 include cellular telephones and portable, laptop, palmtop, hand held, and desktop computers.

Recipient 8 includes a power revive application 16, an information receiving application 20, and system software 22. In one embodiment, recipient 8 includes a program storage device (not shown) tangibly embodying a program, applet, or instructions executable by recipient 8 for performing the method steps of the present invention. An applet is an application or program that can be distributed as an attachment to an internet document and executed by a network browser. The program storage device may be any type of storage media such as magnetic, optical, or electronic storage media. In one embodiment, power reviving application 16 is a separate application from information receiving application 20. In an alternate embodiment, information receiving application 20 and power reviving application 16 are embodied within the same application. Furthermore, information receiving application 20 and power reviving application 16 may each be embodied in stand-alone applications or incorporated into system software 22.

Power revive application 20 is any combination of executable code for controlling the revival of recipient 8 from a power saving mode. Power revive application 20 includes a communication controller 24, an inspector 26, a receiver 28, an interpreter 30, a power reviver 32, and an application launcher 34.

Communication controller 24 is any executable code for opening a communication link to power revive code server 6. Inspector 26 is any executable code for searching for a power revive code on power revive code server 6. Receiver 28 is any executable code for receiving the power revive code from power revive code server 6. Interpreter 30 is any executable code for deciphering the power revive code to discover an associated application and an associated activity. Power reviver 32 is any executable code for reviving recipient 8 from power saving mode. Application launcher 34 is any executable code for launching the associated application and initiating the associated activity.

Information receiving application 20 is any application executable on recipient 8 for receiving information from information server 4. Examples of information receiving application 20 include an email application, an Internet browser, and an information monitoring application, such as a financial information monitoring application or electronic stock ticker.

System software 22 is any combination of executable code that provides an operating environment on recipient 8. System software 22 may be embodied in firmware, such as in a bios, or software, such as in an operating system.

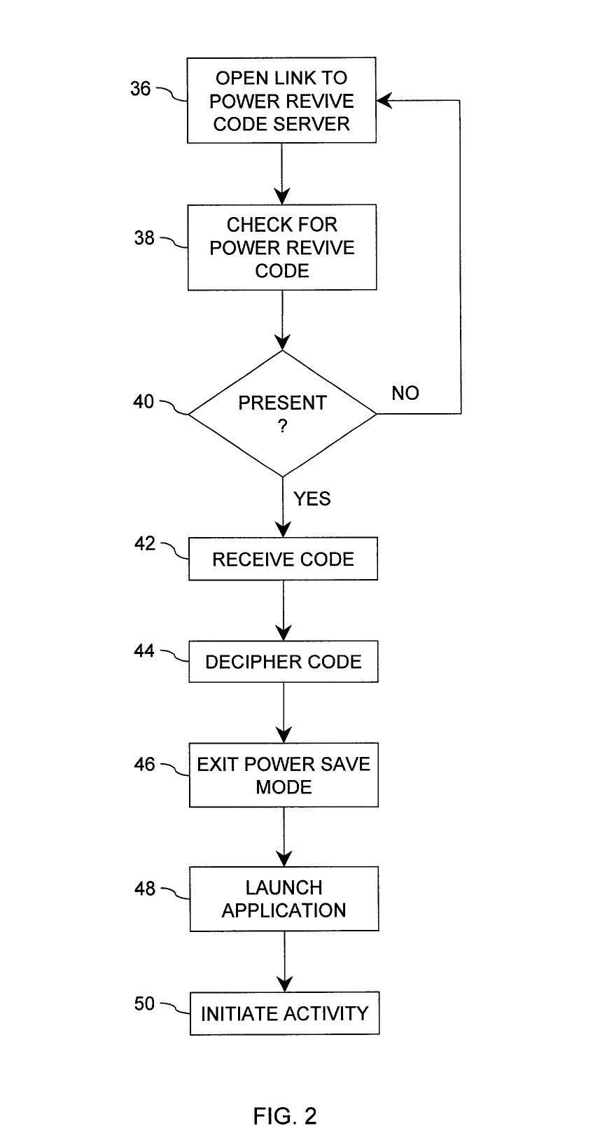

FIG. 2 is a flow chart representing the steps of one embodiment of the present invention. Although the steps represented in FIG. 2 are presented in a specific order, the present invention encompasses variations in the order of steps. Furthermore, additional steps may be executed between the steps illustrated in FIG. 2 without departing from the scope of the present invention.

As the method of the present invention relates to reviving a device from a power saving mode, recipient 8 must be placed into a power saving mode at some point before it is revived. Putting recipient 8 into power saving mode may be accomplished in any manner and is outside the scope of the present invention. Each of the steps of the present invention is possible while recipient remains in the power saving mode.

Communications controller 24 opens 36 a link to a power revive code server 6 and then inspector 26 searches 38 for a power revive code on the power revive code server 6. The communication link to power revive server 6 may then be closed, if desired. If there is no power revive code present 40 on power revive code server 6, a preselected time is allowed to pass and power revive code server 6 is again searched 38 for a power revive code. If necessary, the communication link is once more opened 36 between recipient 8 and power revive code server 6 before searching 38 for the power revive code.

At some point sender 2 sends information to information server 4 and a power revive code to power revive code server 6. Inspector 26 will then detect 40 the power revive code on power revive code server 6.

The power revive code is then received 42 by receiver 28 and deciphered 44 by interpreter 30. Interpreter 30 deciphers 44 the power revive code to discover an application associated with the power revive code. The associated application may be a specifically named application, such as Netscape Messenger or Netscape Navigator, or merely a type of application, such as an email application or an Internet browser. Interpreter 30 may also decipher 44 the power revive code to discover an activity associated with the power revive code. The associated activity is any activity that the associated application is capable of performing. Examples of associated activities include, an email application retrieving email and an Internet browser browsing to an Internet address.

Power reviver 32 revives 46 recipient 8 from the power saving mode and application launcher 34 launches 48 the associated application. The associated activity is the initiated 50. For example, if information receiving application 20 is the associated application, information receiving application 20 is launched 48 and retrieves 50 information from information server 4.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A method for reviving a computer from a power saving mode, the method comprising:
(a) receiving a power revive code;
(b) deciphering the power revive code to discover an associated application;
(c) exiting power save mode; and,
(d) launching the associated application.

2. The method of claim 1 further including, before receiving the power revive code:
(a) opening a link to a server; and,
(b) searching for a power revive code on the server.

3. The method of claim 1 further including:
(a) deciphering the power revive code to discover an associated activity; and,
(b) initiating the associated activity.

4. The method of claim 3 wherein the associated application is an electronic mail viewer and the associated activity includes retrieving electronic mail messages.

5. The method of claim 3 wherein the associated application is an Internet browser and the associated activity includes browsing to an Internet address.

6. The method of claim 3 wherein the associated application is an information monitoring application and the associated activity includes retrieving information.

7. A system for reviving a computer from a power saving mode, the system comprising:
(a) a receiver configured to receive a power revive code;
(b) an interpreter configured to decipher the power revive code to discover an associated application;
(c) a power reviver configured to exit power save mode; and,
(d) an application launcher configured to launch the associated application.

8. The system of claim 7 further including:
(a) a communications controller configured to open a link to a server; and,
(b) an inspector configured to search for a power revive code on the server.

9. The system of claim 7 further including:
(a) the interpreter further configured to decipher the power revive code to discover an associated activity; and,
(b) the application launcher further configured to initiate the associated activity.

10. The system of claim 9 wherein the associated application is an electronic mail viewer and the associated activity includes retrieving electronic mail messages.

11. The system of claim 9 wherein the associated application is an Internet browser and the associated activity includes browsing to an Internet address.

12. The system of claim 9 wherein the associated application is an information monitoring application and the associated activity includes retrieving information.

13. A program storage device readable by a computer, tangibly embodying a program, applet, or instructions executable by the computer to perform method steps for reviving a computer from a power saving mode, the method steps comprising:
(a) receiving a power revive code;
(b) deciphering the power revive code to discover an associated application;
(c) exiting power save mode; and,
(d) launching the associated application.

14. The program storage device of claim 13 wherein the method steps further include, before receiving the power revive code:
(a) opening a link to a server; and,
(b) searching for a power revive code on the server.

15. The program storage device of claim 13 wherein method steps further include:
(a) deciphering the power revive code to discover an associated activity; and,
(b) initiating the associated activity.

16. The program storage device of claim 15 wherein the associated application is an electronic mail viewer and the associated activity includes retrieving electronic mail messages.

17. The program storage device of claim 15 wherein the associated application is an Internet browser and the associated activity includes browsing to an Internet address.

18. The program storage device of claim 15 wherein the associated application is an information monitoring application and the associated activity includes retrieving information.
